(19) United States
(12) Patent Application Publication
(10) Pub. No.: US 2025/0102079 A1
(43) Pub. Date: Mar. 27, 2025

(54) ENERGY CHAIN HAVING PLAIN BEARING RINGS

(71) Applicant: IGUS GMBH, Koeln (DE)

(72) Inventors: Andreas HERMEY, Hennef (DE); Ralf STEEGER, Lohmar (DE)

(21) Appl. No.: 18/716,739

(22) PCT Filed: Jun. 16, 2022
(86) PCT No.: PCT/IB2022/000335

§ 371 Date: Dec. 16, 2024

(30) Foreign Application Priority Data
Dec. 10, 2021 (WO) PCT/IB2021/000853

(51) Int. Cl. F16L 3/015; F16C 17/02

(52) U.S. Cl. CPC F16L 3/015; F16C 17/02; F16C 2361/71

(57) ABSTRACT

An energy chain for guiding lines such as cables, hoses or the like, the energy chain comprising a number of articulatedly interconnected chain links which comprise mutually parallel side parts connected in the longitudinal direction to form two strands which are interconnected by transverse webs. The pin body comprises, at an axially outer end, at least one retaining protrusion which protrudes radially with respect to the bearing surface and by means of which at least the plain bearing ring can be axially inserted into the joint receptacle of the second side part and/or can be axially secured in said joint receptacle. The retaining protrusion axially adjoins the bearing surface, more particularly on a side of the bearing surface axially facing away from the fastening region, more particularly on the outside of the chain link.

### FIELD

The invention relates in general to the field of energy guide chains for guiding lines, such as for example cables, hoses or the like. The invention relates in particular to energy guide chains with chain links in which at least the side plates or side parts thereof are made of plastics material.

### BACKGROUND

Known energy guide chains have a number of chain links connected together in articulated manner which comprise mutually parallel side parts connected in the longitudinal direction to form two strings connected together by crosspieces, there being no need for all the chain links to be provided with crosspieces. Energy guide chains are typically displaceable in such a manner that they form a first run, a second run and a deflection region of a predetermined radius connecting the two runs. The invention is applicable both to energy guide chains with a self-supporting upper run and to energy guide chains with an upper run which slides or rolls on the lower run.

In conventional energy guide chains, the side parts adjacent to one another in the longitudinal direction are connected in pairs in each string by an articulated joint and are swivelable relative to one another about a common swivel axis which forms the joint axis for swiveling the chain links.

In energy guide chains of the above-stated type, the articulated joints each have, for the purposes of the present invention, a joint journal on a first one of the adjacent side parts and a joint receptacle on the other, second one of the adjacent side parts, the articulated joint typically being formed in the manner of a revolute joint by a journal rotatably mounted in the receptacle.

The invention specifically relates to a structure of energy guide chains in which plain bearing rings or plain bearing bushes are used in the articulated joint between the chain links in order to improve plain bearing pairing and/or to reduce wear.

Such an energy guide chain of the above-stated type is disclosed, for example, in EP 0 861 387 A1 or U.S. Pat. No. 6,065,278A. An energy guide chain for guiding lines, where at least some articulated joints in each case have a separate journal body which is mounted on a first side part to form the joint journal, and a plain bearing ring which is mounted in the joint receptacle on the other, second side part. The separate journal body has a fastening region to be fastened by press-fit connection to the first side part and a circumferential bearing surface that is introducible into the plain bearing ring coaxially to the swivel axis.

In the configuration according to EP 0 861 387 A1, the plain bearing ring can take the form of a flanged bush and be inserted from the inside of the chain link into the side part or side plate. In this exemplary embodiment, the journal body has a disk-shaped step in a central region that is arranged as a spacer between the side parts. According to EP 0 861 387 A1, the additional plain bearing ring and additional journal body are intended be inserted into the side parts or side plates prior to assembly of the chain links. While this solution does indeed enable improved sliding and/or wear properties compared to previously known energy guide chains with side plates of plastics material, it has not yet been able to gain acceptance. One drawback would in particular appear to be that it is always necessary to undo the connection between the chain links in order to replace the wear parts, i.e., the plain bearing ring or the journal body. This makes repairing an energy guide chain that is installed or in service very troublesome or virtually unfeasible.

Another energy guide chain with plain bearing rings is described, for example, in WO 2016/047489 A1. In this configuration too, subsequent replacement of the plain bearing parts as wear parts is only possible once the chain links have been undone in the longitudinal direction since the links are inserted on the mutually facing sides of the side parts, i.e., they are inaccessible from the outside.

However, it is not only during original manufacture that it should be possible to fit the wear parts of the articulated joint easily or with little effort. In view of ever more stringent sustainability requirements, it would be desirable for subsequent, in particular straightforward, replacement of wear parts to be possible. This would make it possible to replace only these wear parts of the articulated joint in order to re-equip the energy guide chain with new articulated joints, i.e., to be able in this way to avoid having to replace the entire energy guide chain.

A further energy guide chain of the above-stated type is known, for example, from WO 2007/121715.

### SUMMARY

It is therefore a first object of the invention to improve the configuration of an articulated joint with a plain bearing ring in an energy guide chain of the above-stated type, in such a way that subsequent replacement of wear parts of the articulated joint is also simplified, it being intended for assembly or initial manufacture also to remain as simple as possible and in particular for a robust articulated joint also to be achieved.

This is enabled by an energy guide chain or a configuration with chain links.

The object can be achieved in its simplest form in that the separate or additional journal body is configured such that it comprises at least one retaining projection protruding radially relative to the bearing surface at an axially outer end. Using this retaining projection, at least the plain bearing ring can be introduced axially into the joint receptacle of the second side part and/or be secured axially in the joint receptacle or retained therein against axial detachment.

In particular, the retaining projection can axially adjoin the bearing surface on a side of the bearing surface axially remote from the fastening region, in particular on the outside relative to the chain link.

This configuration on the one hand enables a simplified construction of the plain bearing ring or rings of the articulated joint which can take the form of, for example, flangeless, axially short plain bearing bushes, since each plain bearing ring remains retained on the side part by the retaining projection of the journal body. On the other hand, it makes it possible for the journal body to be subsequently readily axially detached, in particular from the outside of the chain link, such that the journal body and plain bearing ring(s) are readily axially detachable from the outside. Conversely, this also enables straightforward axial assembly, the plain bearing ring in particular also being easily assemblable together with the journal body. A preferred configuration is one in which assembly and disassembly can be carried out from the outside of the chain link, i.e., not from the receiving space for the lines.

In one advantageous embodiment, the journal body is configured such that it can also be used to counteract unwanted detachment of the chain links, in particular by the side parts spreading apart transversely of the longitudinal direction. This can be achieved in a simple manner by the at least one retaining projection protruding radially beyond the external diameter of the plain bearing ring and/or the joint receptacle and thus engaging over the second side part so as to retain the latter axially in the direction transverse to the longitudinal direction on the first side part to which the journal body is fastened. The retaining projection can thus perform two functions, namely securing the at least one bearing ring axially or in the lateral direction on the chain link and at the same time also securing the one side part to the other in the lateral direction. This accordingly enables a more robust articulated joint between the chain links that can withstand high forces. The term axial here in particular relates to the axial direction of the swivel axis, while the term radial in particular denotes a direction perpendicular to the swivel axis.

One or more circumferentially distributed retaining projections may be provided on the journal body. A preferred configuration, however, is one in which the retaining projection is embodied in the manner or form of an annular washer-type retaining flange. The latter may preferably be configured to completely surround the swivel axis. The external diameter of the retaining flange is preferably greater than the external diameter of the plain bearing ring and/or greater than the diameter of the joint receptacle.

The fastening region is in particular intended to be fastened to the first side part, which is to have the joint journal, or to a further separate journal body that is mounted on or in the first side part.

In order to transmit forces in the longitudinal direction of the energy guide chain, in particular tensile and shear forces through the plate strings or strings of side parts, it is advantageous for the journal body to have a coaxial fastening cylinder in the fastening region that is fastened, for force transmission in the longitudinal direction, in a matching receptacle or a corresponding seat of the first side part. The corresponding receptacle may in particular be provided as a receiving ring that protrudes axially from the body or from a major face of the first side part. The fastening cylinder can be retained axially in the receiving ring by any suitable connection method, in particular a press-fit connection, screw connection and/or snap-fit connection. Forces advantageously flow in the longitudinal direction between the joined side parts via the fastening cylinder and the receptacle thereof, but not via the axial connection with which the journal body is mounted or retained on the corresponding side part.

The journal body advantageously forms at least part, in particular a force-transmitting component, of the joint journal on the first side part, and can in particular form a detachable joint journal. The journal body is in this case preferably mounted non-rotatably on the first side part, but this is not mandatory.

In order to ensure a particularly robust connection, one embodiment, which is also advantageous in terms of assembly and disassembly, provides that the journal body with the fastening cylinder thereof is retained in the receiving ring with the assistance of a fastening screw. Precisely one or just one fastening screw may be or have been screwed for this purpose to the first side part coaxially to the swivel axis.

The fastening screw of the joint journal is preferably a plastics self-tapping screw. The plastics self-tapping screw may preferably be or have been screwed into a coaxial opening that is provided in the body of first side part as a through-hole or indeed as a blind hole for the plastic self-tapping screw.

In order to avoid undesired force transmission in the longitudinal direction of the energy guide chain onto the fastening screw, the journal body preferably has a coaxial core hole through which the fastening screw is guided with radial clearance such that no alternating loads are transmitted via the fastening screw during back and forth movement.

In order to achieve defined sliding surfaces that rotate toward one another when the chain links are bent, it is advantageous for the detachable journal body to be fastened non-rotatably to the respective side part. This can be easily achieved while maintaining simple assembly and disassembly, in particular in conjunction with a screw connection, if the journal body has profiling in the fastening region for form-locked and non-rotatable connection with corresponding profiling on the (first) side part. One simple configuration that is economical with regard to materials provides that the profiling in particular in each case comprises a first coaxial form-locking crown on the journal body and surrounding the fastening cylinder and a cooperating second coaxial form-locking crown on the receiving ring, in particular on the end face of the receiving ring. A crown serving to provide form-locking may in particular in each case be provided with claws on the end face, end-face toothing or the like or with projections and recesses alternating in the circumferential direction about the swivel axis that engage with one another for non-rotatable connection.

In particular if it forms a sliding surface for the plain bearing ring on its bearing surface, the journal body can be manufactured from a specific plastics material that differs from the plastics material of the side parts. In particular, the journal body can be made of a higher grade plastics material or a plastics material selected with regard to favorable plain bearing pairing and/or improved sliding and/or wear properties.

A compact structure that is economical with regard to materials is fundamentally desirable for the replaceable journal body. In one advantageous embodiment, the journal body is embodied in the manner of a stopper having an axial structural length which is significantly shorter than the diameter, in particular than the diameter of the bearing surface. The journal body is thus relatively short, for example shorter than conventional joint pins that extend through two side parts. The structural length of the journal body is preferably only insignificantly greater than the wall thickness of a side part in the region around the articulated joint, for example less than 1.2 times the wall thickness.

Particularly compact structure of the journal body can be provided by the fastening region being arranged axially, preferably at least partially or completely, within a cylinder formed by the bearing surface, the fastening cylinder particularly preferably being formed by an annularly circumferential recess and/or not protruding axially beyond the bearing surface. The fastening region may in particular be embodied at least in part or predominantly at the face at the axial end of the journal body remote from the retaining projection.

The journal body may be dimensioned such that the axial distance between the retaining projection protruding relative to the bearing surface and the one axially outer end and the other axially outer end is only insignificantly greater than the wall thickness of the second side part to be bearing mounted, such that axial movement clearance remains for relative swivel movement.

Two basic structures can fundamentally be considered for providing favorable plain bearing pairing using at least one additional plain bearing ring.

In order to form sliding surfaces that can rotate on one another, the journal body may itself form a sliding surface on the bearing surface thereof. The bearing surface of the journal body can for this purpose have an outer sliding surface with which the inner surface of the plain bearing ring interacts rotatably.

Alternatively, the plain bearing pairing may also be embodied by two interacting sliding rings that form or include the sliding surfaces of the articulated joint that are rotatable on one another. A first plain bearing ring can for this purpose be fastened non-rotatably in the joint receptacle of the second side part and a further second plain bearing ring can be arranged, rotatably or non-rotatably, on the bearing surface of the journal body. The second plain bearing ring then forms an outer surface with which an inner surface of the first plain bearing ring interacts rotatably in order to provide the sliding surfaces that are rotatable on one another. One advantage of this configuration is that the journal body need not be manufactured from a tribologically optimized plastics material and is optionally also subject to no or only relatively low wear. Among other things, the cost of higher grade tribological plastics materials can accordingly be minimized.

The further, second plain bearing ring between the journal body and the first plain bearing ring can be loosely rotatably or floatingly retained on the journal body such that frictional wear thereof can be automatically distributed around the circumference. The first plain bearing ring can then be selected from a tribologically optimized and more wear-resistant material such that optionally only the second plain bearing ring, which is intended to be subjected to greater wear, need be replaced as a wear part in order to reinstate the articulated joint. This can, however, likewise be provided if the second plain bearing ring is mounted non-rotatably on the journal body, in particular non-rotatably by press-fit connection to the bearing surface thereof. This also enables simple subsequent replacement of the second plain bearing ring.

The first or only plain bearing ring preferably has means for form-locked, non-rotatable connection to the corresponding side part. A non-rotatable connection can additionally or alternatively also be achieved by press-fit connection in the joint receptacle on the second side part. It is advantageous for there to be no rotation between the plain bearing ring and its receptacle or the joint receptacle on the side part, in order to avoid wear to this receptacle or the joint receptacle and thus to the side part or chain link itself.

It is advantageous structurally and with regard to handling for the journal body to be manufactured as a cylindrical, in particular rotationally symmetrical, component.

The journal body is preferably manufactured as a molded part of plastics material, in particular as an injection molding, it being possible to select for this purpose, in line with requirements that differ from the requirements for the side plates themselves, a possibly more suitable plastics material that differs from the plastics material of the side parts.

The side parts and/or chain links per se can also be manufactured from plastics material, in particular as injection moldings. To reduce costs, the side parts can be manufactured from a less costly plastics material that differs from the plain bearing ring and/or the journal body. The chain links are preferably manufactured from a fiber-reinforced thermoplastics material, for example a glass fiber reinforced polyamide.

The or each plain bearing ring, on the other hand, is preferably manufactured from a tribologically optimized tribopolymer, preferably a tribopolymer with one or more solid lubricants in a suitable matrix polymer.

If the journal body provides a sliding surface, it is advantageous for at least the bearing surface of the journal body to be manufactured from a tribopolymer with one or more solid lubricants.

To further simplify assembly and maintenance, the journal body can have one or more snap-fit connectors for axial retention of a plain bearing ring such that, on assembly/disassembly, the plain bearing ring can be mounted on or detached from the chain link in just one step together with the journal body.

In an energy guide chain according to the invention, all the chain links can have the proposed articulated joint configuration with at least one plain bearing ring and a journal body, or at least a predominant proportion, or indeed just the chain links in a longitudinal portion that is particularly susceptible to wear.

The invention thus also relates to just a short portion of an energy guide chain with at least two chain links. Each articulated joint can here be configured according to one of the preceding embodiments.

The features described above and claimed hereinafter are each to be considered to be individually essential to the invention. In particular, the subjects of the subclaims may constitute independent inventions which may also be the subject-matter of a divisional application optionally even without the characterizing or other features of the present main claim.

### BRIEF DESCRIPTION OF THE DRAWINGS

Further details, features and advantages of the invention are revealed without limitation to the above by the following description of some preferred embodiments made with reference to the appended figures, in which:

FIGS. 1A-1D: show a first exemplary embodiment of the invention with a perspective view of three joined chain links as a longitudinal portion of an energy guide chain (FIG. 1A), a magnified portion thereof with an exploded representation of an articulated joint (FIG. 1B), a vertical cross-section through the assembled articulated joint (FIG. 1C) and a perspective view of a journal body or pin part (FIG. 1D);

FIG. 2: shows a second exemplary embodiment of the invention in perspective view by way of an exploded representation of an articulated joint;

FIG. 3: shows a third exemplary embodiment of the invention in perspective view by way of an exploded representation of an articulated joint;

FIG. 4: shows a fourth exemplary embodiment of the invention in perspective view by way of an exploded representation of an articulated joint;

FIGS. 5A-5D: show a fifth exemplary embodiment of the invention with a different energy guide chain construction, by way of a vertical cross-section through the articulated joint of two link plates (FIG. 5A), a magnified portion thereof (FIG. 5B) and by way of perspective views of two variants of a journal body or pin part each with a plain bearing ring retained thereon (FIG. 5C/FIG. 5D); and

FIG. 6: shows a schematic side view of a complete energy guide chain, in this case by way of example with a sliding or rolling upper run according to the prior art.

### DETAILED DESCRIPTION

FIG. 6 shows a known energy guide chain 1 for guiding supply lines (not shown) having a number of chain links 2 connected together in articulated manner, in this case of per se known construction, for example according to WO 99/57457 A1. The energy guide chain 1 is displaceable to and fro and in so doing variably forms a loop comprising an upper run 3, a lower run 4 and a deflection arc or deflection region 5 connecting them. In the example from FIG. 6, rollers 7 are provided at regular intervals on selected chain links 2 of the upper run 3 and the lower run 4. The rollers 7 are arranged such that they protrude beyond the narrow sides of the side parts facing the inside of the loop toward the opposite run 3 or 4 respectively. On displacement of the energy guide chain 1, the rollers 7 allow the upper run 3 to roll firstly on the lower run 4 and optionally furthermore on a separate support surface 6, for example on a guide channel. The invention also relates to an energy guide chain 1 for applications with a self-supporting upper run (not shown).

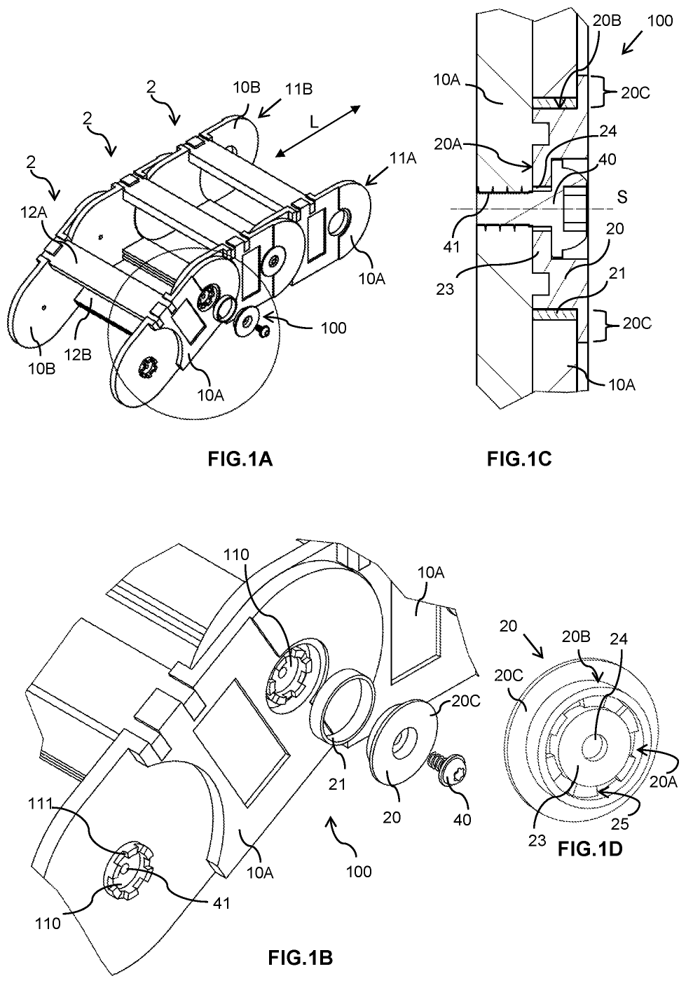

FIG. 1A shows a longitudinal portion of an energy guide chain 1 here composed purely by way of example of three chain links 2 connected to one another in articulated or swivelable manner in the longitudinal direction L.

Each chain link has two link plates or side parts 10A, 10B which are connected together and held parallel to one another by crosspieces 12A, 12B. FIGS. 1-4 show chain links of two-part construction, in which the two mirrored side parts 10A, 10B are connected in one piece by a crosspiece, for example the inner crosspiece 12B in the deflection arc, and only one crosspiece 12A is detachable for opening the chain link 2. Other constructions, for example with four-part chain links 2 each having two detachable crosspieces 12A, 12B, also fall within the scope of the invention. The side parts 10A, 10B are connected or linked together on each side in the longitudinal direction to form a string 11A, 11B.

In order to connect the chain links 2 in articulated manner, two side parts 10A and 10B adjacent in the longitudinal direction L are each connected by an articulated joint 100 and are swivelable relative to one another about a common swivel axis S. A first exemplary embodiment of the articulated joint 100 will now be explained in greater detail with reference to FIGS. 1A-1D.

In FIGS. 1A-1D, the articulated joint 100 is in each case formed by a kind of joint journal on one of the adjacent side parts 10A, regarded as the first, and by a joint receptacle on the other side part 10A, regarded as the second, this applying mutatis mutandis to the side parts 10B in the other plate string 11B. Each side part 10A, 10B has a joint journal at one end region and a joint receptacle at the other end region, the end regions overlapping one another in the longitudinal direction L.

The articulated joints 100 each have a journal body 20 that is manufactured separately from or is separate from the side parts 10A, 10B and is mounted on the side part 10A, regarded as the first, to form the joint journal.

The articulated joints 100 in FIGS. 1A-1D each furthermore have a plain bearing ring 21 that, in the assembled state (FIG. 1C), is mounted in the joint receptacle on the second side part 10A.

At the axial end facing the inside of the chain, the journal body 20 has a fastening region 20A that has a fastening cylinder 23 (FIG. 1D) coaxial with the swivel axis S for form-locked and/or force-locked fastening. The fastening cylinder 23 is fastened in a seat or receiving ring 110 of the side part 10A (also similarly mirrored on side part 10B). The fastening cylinder 23 is inserted into the receiving ring 110 with a slight interference or matching fit or by press-fit connection, such that this connection transmits force, in particular in the longitudinal direction L, between the connected side parts 10A. The receiving ring 110 protrudes coaxially from the outer wall surface of the side plate 10A (and similarly also from the side plate 10B) and forms a seat for fastening the journal body 20.

To fasten the journal body 20 in place, in FIGS. 1A-1D the latter is retained with its fastening cylinder 23 by a screw connection with the assistance of a coaxial plastics self-tapping screw 40 in the receiving ring 110, but other connections are also possible. The plastics self-tapping screw 40 is screwed in through a coaxial opening 41 in the body of the side part 10A. The journal body has a coaxial core hole 24 with clearance for the plastics self-tapping screw 40, such that no force is transmitted in the longitudinal direction L.

The journal body 20 furthermore has a circumferential, cylindrical bearing surface 20B that, in the assembled state, is introduced coaxially to the swivel axis into the plain bearing ring 21 and is surrounded by the latter. The journal body 20 is manufactured from a plastics material as a cylindrical, rotationally symmetrical injection molding.

In the example from FIGS. 1A-1D, the plain bearing surfaces that rotate on one another are formed by the circular cylindrical bearing surface 20B and the circular cylindrical inner surface of the plain bearing ring 21 and have an appropriate bearing clearance therebetween, see (FIG. 1C). In this example, the journal body 20 and the plain bearing ring 21 can be manufactured from a suitable tribopolymer with solid lubricants, in each case selected such that favorable plain bearing pairing is achieved.

According to the invention, the journal body 20 furthermore has, at its axially outer end remote from the fastening region 20A, one or more retaining projections protruding radially relative to the bearing surface, in FIGS. 1A-1D in the form of an annular washer-type retaining flange 20C that axially adjoins the bearing surface 20B on the outside, as is most clearly apparent from FIG. 1C and FIG. 1D. With the assistance of the retaining flange 20C, the plain bearing ring 21 is axially introducible into the joint receptacle of the side part and can also be axially secured therein against detachment along the swivel axis S.

FIG. 1C further shows that the retaining projection or retaining flange 20C protrudes radially beyond the external diameter of the plain bearing ring 21 and/or the joint receptacle and indeed engages over the second side part 10A, here the outer of the two side parts 10A, so as to retain it axially on the first, here inner side part 10A in a direction transverse to the longitudinal direction. This markedly increases the lateral stability of the chain link 2 and at the same simplifies assembly and disassembly, since the plain bearing ring 21 can be fitted at the same time and remains readily accessible from the outside. The plain bearing ring 21 may be press-fitted into the side part 10A by way of the retaining flange 20C when the journal body 20 is screwed in using the plastics self-tapping screw 40, such that the plain bearing ring 21 is held non-rotatably by a press-fit connection in the other side part 10A.

FIG. 1B and FIG. 1D additionally show profiling for form-locked and non-rotatable connection between journal body 20 and side part 10. To this end, a first form-locking crown 25 coaxial to the swivel axis S and with peripherally alternating claws is provided on the journal body 20. Said crown cooperates with a corresponding second coaxial form-locking crown 111 provided on the end face of the receiving ring 110. Instead of the claws shown, similar to a dog clutch, suitable end-face toothing or the like may also be provided. A self-centering configuration of the form-locking crowns 25, 111 is also possible.

As FIG. 1C shows most clearly, the journal body 20 takes the form of a stopper having an axial structural length along the swivel axis S which is significantly shorter than the diameter of the bearing surface 20B. The fastening region 20A is here arranged axially completely or virtually completely within a notional cylinder formed by the bearing surface 20B. The fastening cylinder 23 is formed by an annularly circumferential recess, in which the form-locking crown 25 is likewise provided. As FIG. 1C shows, the fastening cylinder 23 does not project axially beyond the bearing surface 20B, resulting in a compact structure of the stopper-like journal body 20.

In FIGS. 1A-1D, the bearing surface 20B of the journal body 20 forms an outer sliding surface with which the inner surface of the plain bearing ring 21 interacts rotatably, i.e., the sliding plane lies between the outer circumferential surface of the body 20 and the inner circumferential surface of the plain bearing ring 21.

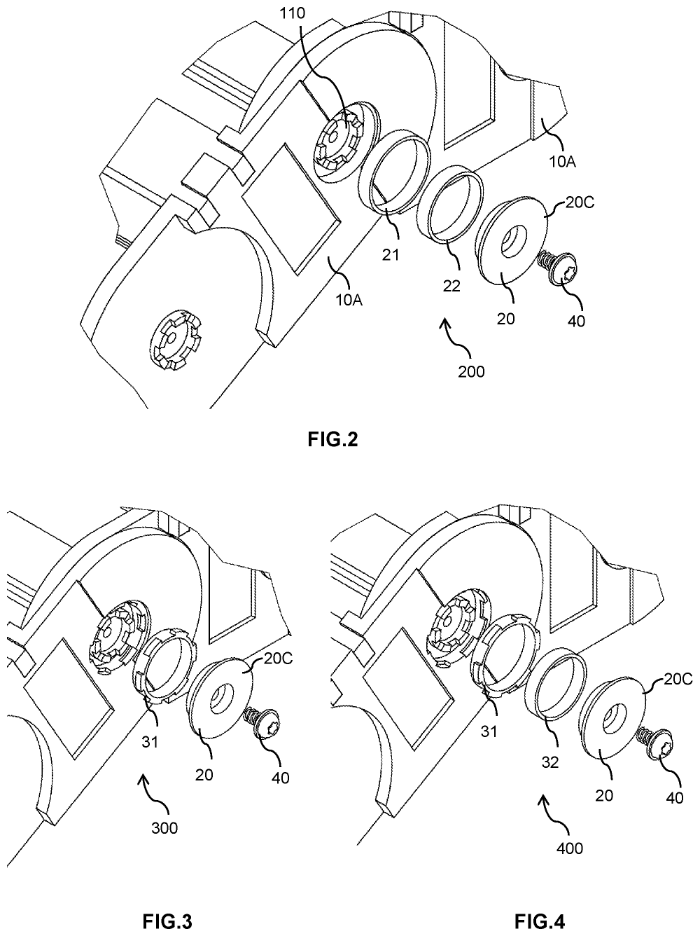

FIG. 2 shows a variant of the articulated joint 200 with a further plain bearing ring 22; parts which are the same and correspond to FIGS. 1A-1D not being described again.

In FIG. 2, a first, outer plain bearing ring 21 is fastened non-rotatably in the joint receptacle of the second side part 10A. A second, inner plain bearing ring 22 is mounted rotatably or non-rotatably on the bearing surface 20B of the journal body 20, preferably pre-fitted non-rotatably by a force-locking press fit on the journal body 20. The second plain bearing ring 22 has a circular-cylindrical outer surface with which the circular-cylindrical inner surface of the first plain bearing ring 21 interacts rotatably in order to form sliding surfaces rotatable on one another. Here the sliding plane lies between the outer circumferential surface of the inner plain bearing ring 22 and the inner circumferential surface of plain bearing ring 21. Here too, the plain bearing ring 21 is press-fitted force-lockingly into the corresponding side part 10A, this being advantageously achievable in the course of screw-fastening of the journal body 20.

FIG. 3 shows an articulated joint 300 as a variant of the articulated joint 100; parts which are the same and correspond to FIGS. 1A-1D not being described again. In articulated joint 300, the plain bearing ring 31, as in FIGS. 1A-1D, forms, with the outer circumferential surface of the bearing surface 20B of the journal body 20, the plain bearing surfaces which rotate on one another. The essential difference consists in the fact that the plain bearing ring 31 is embodied for form-locked, non-rotatable connection with the side plate 10A, such that no press-fit connection is needed and assembly/disassembly is further simplified. To this end, the plain bearing ring 31 has corresponding profiling, e.g., toothing or the like, on the outside thereof which engages in form-locked manner in corresponding profiling in the joint receptacle of side part 10A.

FIG. 4 shows a modification of the articulated joint 200 of FIG. 2 with an articulated joint 400 comprising two plain bearing rings 31, 32, the outer plain bearing ring 31 being configured, similarly to FIG. 3, for a form-locking connection.

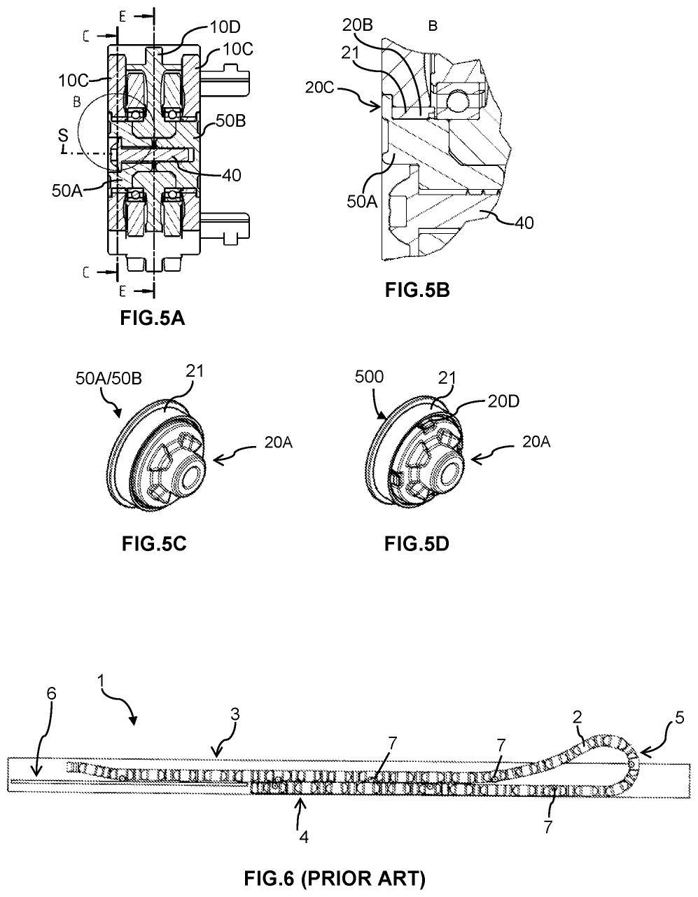

Finally, FIGS. 5A-5D show a further exemplary embodiment of chain links of a different construction, with clevis-like link plates. Further details about the construction of this energy guide chain can be found in WO 2022/123308 A1, the teaching of which is hereby included for the sake of brevity and is referred to in this respect. In FIGS. 5A-5D too, journal bodies 50A/50B are provided which in each case have a fastening region 20A, a bearing region 20B for a plain bearing ring 21 and a radial projection, here too in the manner of an annular flange 20C.

Only the significant differences will be briefly explained. In FIGS. 5A-5D, as a result of the link plate construction, in each case two journal bodies 50A/50B are connected together opposingly by a screw connection using a self-tapping screw 40 to form a joint journal. The annular flanges 20C here too in each case axially retain the plain bearing ring and additionally reinforce an outer clevis plate 10C against spreading apart away from an inner link plate 10D. By way of journal bodies 50A/50B, in each case one plain bearing ring 21 is retained for swivelable bearing-mounting of the side parts 10C/10D, the plain bearing ring 21 forming the rotating plain bearing surface with the respective bearing region and being fastened non-rotatably to the link plate 10C.

Finally, FIG. 5D further shows a possible additional feature in the form of a journal body 500, which has catch means or snap-fit connector means 20D for axially retaining the plain bearing ring 21 during assembly/disassembly despite the bearing clearance between plain bearing ring 21 and journal body 500.

### LIST OF REFERENCE SIGNS

1 Energy guide chain
2 Chain link
3, 4 Chain run (e.g., upper run/lower run)
5 Deflection arc
6 Support
7 Rollers
10A, 10B Side part (side plate)
11A, 11B String
12A, 12B Crosspiece
20 Journal body
20A Fastening region
20B Bearing surface
20C Retaining projection/retaining flange
21, 22, 31, 32 Plain bearing ring
23 Fastening cylinder
24 Core hole
25 Form-locking crown
40 Fastening screw
41 Opening
100; 200; 300; 400 Articulated joint
110 Receiving ring/seat
111 Form-locking crown
L Longitudinal direction
S Swivel axis

What is claimed is:

1-15. (canceled)

16. An energy guide chain to guide at least one line, the energy guide chain comprising:
a number of chain links connected together in articulated manner which comprise mutually parallel side parts connected in a longitudinal direction to form two strings connected together by crosspieces;
two side parts adjacent in the longitudinal direction each being connected by an articulated joint and being swivelable relative to one another about a common swivel axis, and the energy guide chain displaceable such that the energy guide chain forms a first run, a second run and a deflection region connecting the two runs;
the articulated joints each comprising a joint journal on a first side part of the adjacent side parts and a joint receptacle on a second side part of the adjacent side parts,
wherein at least some of the articulated joints in each case comprise a separate journal body which is mounted on the first side part to form the joint journal, and at least one plain bearing ring which is mounted in the joint receptacle on the second side part, the separate journal body having a fastening region for form-locked and/or force-locked fastening, and the separate journal body having a circumferential bearing surface introducible into the plain bearing ring coaxially to the swivel axis, and
wherein the journal body comprises at least one retaining projection protruding radially relative to the bearing surface at an axially outer end and protruding radially beyond an external diameter of the plain bearing ring and/or the joint receptacle and engaging over the second side part, using which retaining projection at least the plain bearing ring is introducible axially into the joint receptacle of the second side part and/or securable axially therein, the retaining projection also securing the first side part to the second side part in a lateral direction.

17. The energy guide chain according to claim 16, wherein the retaining projection has a form of an annular washer-type retaining flange.

18. The energy guide chain according to claim 16, wherein the journal body has a coaxial fastening cylinder in the fastening region that is fastened, for force transmission in the longitudinal direction, in a receiving ring of the first side part that protrudes axially from the body of the first side part, the fastening cylinder being retained axially in the receiving ring by a press-fit connection, screw connection and/or snap-fit connection.

19. The energy guide chain according to claim 18, wherein the journal body is retained with its fastening cylinder in the receiving ring by way of a fastening screw, the fastening screw screwed into a coaxial opening in a body of the first side part and/or the journal body having a coaxial core hole through which the fastening screw is guided with radial clearance such that no force is transmitted to the fastening screw in the longitudinal direction.

20. The energy guide chain according to claim 18, wherein the journal body has profiling in the fastening region for form-locked and non-rotatable connection with corresponding profiling on the first side part.

21. The energy guide chain according to claim 16, wherein the journal body has a form of a stopper having an axial structural length which is significantly shorter than a diameter of the bearing surface, the fastening region being arranged axially within a cylinder formed by the bearing surface.

22. The energy guide chain according to claim 16, wherein the bearing surface of the journal body has an outer sliding surface with which an inner surface of the plain bearing ring interacts rotatably to form sliding surfaces rotatable on one another.

23. The energy guide chain according to claim 16, wherein a first plain bearing ring is fastened non-rotatably in the joint receptacle of the second side part and a further second plain bearing ring is arranged on the bearing surface of the journal body, the second plain bearing ring forming an outer surface with which an inner surface of the first plain bearing ring interacts rotatably to form sliding surfaces rotatable on one another.

24. The energy guide chain according to claim 16, wherein the at least one plain bearing ring is configured for form-locked, non-rotatable connection and/or is retained non-rotatably in the joint receptacle on the second side part by a press-fit connection.

25. The energy guide chain according to claim 16, wherein:
the journal body is formed of plastics material as a cylindrical component; and/or
the side parts are formed of a plastics material that differs from the plain bearing ring and/or from the journal body.

26. The energy guide chain according to claim 16, wherein:
the or each plain bearing ring is formed of a tribopolymer with one or more solid lubricants; and/or
at least the bearing surface of the journal body is formed of a tribopolymer with one or more solid lubricants.

27. The energy guide chain according to claim 16, wherein the journal body has a snap-fit connector for axial retention of a plain bearing ring during assembly/disassembly.

28. An energy guide chain portion comprising:
at least two chain links comprising mutually parallel side parts connected in a longitudinal direction to form two strings connected together by crosspieces;
two side parts adjacent in the longitudinal direction each being connected by an articulated joint and being swivelable relative to one another about a common swivel axis, the articulated joints each comprising a joint journal on a first side part of the adjacent side parts and a joint receptacle on a second side part of the adjacent side parts,
wherein at least some of the articulated joints in each case comprise a separate journal body which is mounted on the first side part to form the joint journal, and at least one plain bearing ring which is mounted in the joint receptacle on the second side part, the separate journal body having a fastening region for form-locked and/or force-locked fastening, to the first side part or to a further, separate journal body which is mounted on or in the first side part, and the separate journal body having a circumferential bearing surface introducible into the plain bearing ring coaxially to the swivel axis, and
wherein the journal body comprises at least one retaining projection protruding radially relative to the bearing surface at an axially outer end and protruding radially beyond an external diameter of the plain bearing ring and/or the joint receptacle and engaging over the second side part, the retaining projection also securing the first side part to the second side part in a lateral direction and using which retaining projection at least the plain bearing ring is introducible axially into the joint receptacle of the second side part and/or securable axially therein.

29. The energy guide chain portion according to claim 28, wherein the retaining projection has a form of an annular washer-type retaining flange.

30. The energy guide chain portion according to claim 28, wherein the journal body has a coaxial fastening cylinder in the fastening region that is fastened, for force transmission in the longitudinal direction, in a receiving ring of the first side part that protrudes axially from the body of the first side part, the fastening cylinder being retained axially in the receiving ring by a press-fit connection, screw connection and/or snap-fit connection.

31. The energy guide chain portion according to claim 30, wherein:
the journal body is retained with its fastening cylinder in the receiving ring by way of a fastening screw, the fastening screw screwed into a coaxial opening in a body of the first side part and/or the journal body having a coaxial core hole through which the fastening screw is guided with radial clearance such that no force is transmitted to the fastening screw in the longitudinal direction; or
the journal body has profiling in the fastening region for form-locked and non-rotatable connection with corresponding profiling on the first side part.

32. The energy guide chain portion according to claim 28, wherein the journal body has a form of a stopper having an axial structural length which is significantly shorter than a diameter of the bearing surface, the fastening region being arranged axially within a cylinder formed by the bearing surface.

33. The energy guide chain portion according to claim 28, wherein a first plain bearing ring is fastened non-rotatably in the joint receptacle of the second side part and a further second plain bearing ring is arranged on the bearing surface of the journal body, the second plain bearing ring forming an outer surface with which an inner surface of the first plain bearing ring interacts rotatably in order to form sliding surfaces rotatable on one another.

34. The energy guide chain portion according to claim 28, wherein:
the at least one plain bearing ring is configured for form-locked, non-rotatable connection and/or is retained non-rotatably in the joint receptacle on the second side part by a press-fit connection; or
the journal body has a snap-fit connector for axial retention of a plain bearing ring during assembly/disassembly.

35. The energy guide chain portion according to claim 28, wherein:
the journal body is formed of plastics material as a cylindrical component, and/or the side parts are formed of a plastics material that differs from the plain bearing ring and/or from the journal body; and/or
the or each plain bearing ring is formed of a tribopolymer with one or more solid lubricants, and/or at least the bearing surface of the journal body is formed of a tribopolymer with one or more solid lubricants.

36. The energy guide chain portion according to claim 28, wherein the retaining projection is axially adjoining the bearing surface on a side of the bearing surface axially remote from the fastening region and/or on an outside relative to the chain link.

37. The energy guide chain according to claim 16, wherein the retaining projection is axially adjoining the bearing surface on a side of the bearing surface axially remote from the fastening region and/or on an outside relative to the chain link.
